(19) United States
(12) Patent Application Publication
(10) Pub. No.: US 2016/0239019 A1
(43) Pub. Date: Aug. 18, 2016

(54) AUTONOMOUS SEARCH SYSTEM, OPERATION TERMINAL, MOBILE SEARCH DEVICE, AND SEARCH CONTROL METHOD

(71) Applicant: MITSUBISHI HEAVY INDUSTRIES, LTD., Tokyo (JP)

(72) Inventors: Yasuo FUJISHIMA, Tokyo (JP); Masato IEHARA, Tokyo (JP); Naoto KAWAUCHI, Tokyo (JP); Natsuki MATSUNAMI, Tokyo (JP); Tomohiro TAMI, Tokyo (JP)

(21) Appl. No.: 15/029,750

(22) PCT Filed: Oct. 16, 2014
(86) PCT No.: PCT/JP2014/077512

§ 371 Date: Apr. 15, 2016

(30) Foreign Application Priority Data
Oct. 22, 2013 (JP) 2013-219684

(51) Int. Cl. G05D 1/00; H04N 7/18; H04R 1/08; G06F 17/30

(52) U.S. Cl. CPC G05D 1/0016; G06F 17/30424; G06F 17/30259; H04N 7/183; H04R 1/08; G05D 1/0038

(57) ABSTRACT

An autonomous search system includes an operation terminal 10 and a mobile search device 11. The operation terminal 10 includes an input unit 21 to which a search object and a predetermined action can be separately input, a terminal-side communication unit 24 that transmits, to the mobile search device 11, object data for the input search object and action data for the input predetermined action, and a terminal-side controller 25 connected to the input unit 21 and the terminal-side communication unit 24. The mobile search device 11 autonomously searches for the search object based on the object data transmitted from the operation terminal 10 and carries out the predetermined action relative to the search object based on the action data transmitted from the operation terminal 10.

### FIELD

The present invention relates to an autonomous search system, an operation terminal, a mobile search device, and a search control method for the autonomous search system, where the operation terminal and the mobile search device are used to search for a search object to be searched for.

### BACKGROUND

In the past, a remote control robot device remotely controlled by an operator has been known (for example, refer to Patent Literature 1). In this remote control robot device, the remote control by the operator and an autonomous movement of the robot itself are coordinated to achieve a stable movement. Additionally, the remote control robot device has an ultrasonic sensor to detect the surrounding circumstances of the robot and determines whether an obstacle is in the way based on distance data measured with the ultrasonic sensor. When determining that an obstacle is in the way, the remote control robot device autonomously avoids the obstacle in a case where no remote control is given by the operator.

### CITATION LIST

### Patent Literature

Patent Literature 1: Japanese Laid-open Patent Publication No. 6-155350

### SUMMARY

### Technical Problem

As described above, while autonomously moving, a remote control robot device disclosed in Patent Literature 1 avoids an obstacle as an action provided in advance, in a case where no remote control is given by an operator. Here, while a mobile search device such as the remote control robot device is autonomously moving, in order to cause the mobile search device to carry out an action other than the avoidance of an obstacle, an instruction for carrying out a predetermined action relative to a predetermined object needs to be provided in advance. For example, when an instruction is provided for the autonomous movement of the mobile search device, it is typically considered to provide an action program for carrying out a predetermined action relative to a predetermined object (e.g., an action program for gripping a drill) as an executive instruction (e.g., an instruction for gripping a drill). In this case, however, because the instruction is provided for carrying out the predetermined action relative to the predetermined object, when an object differs from the predetermined one, the predetermined action cannot be carried out relative to that different object. Taking this into account, the action programs and the executive instructions need to be prepared by the number of combinations of predetermined objects and predetermined actions. Therefore, it is difficult to use for multiple purposes.

Considering this situation, an object of the present invention is to provide an autonomous search system, an operation terminal, a mobile search device, and a search control method that can be used for multiple purposes.

### Solution to Problem

According to an aspect of the present invention, an autonomous search system comprising: an operation terminal; and a mobile search device configured to search for a search object while moving based on information transmitted from the operation terminal. The operation terminal includes: an input unit to which the search object and a predetermined action to be carried out relative to the search object can be separately input; a terminal-side communication unit that transmits, to the mobile search device, the search object input on the input unit as object data and transmits, to the mobile search device, the predetermined action input on the input unit as action data; and a terminal-side controller connected to the input unit and the terminal-side communication unit. The mobile search device includes: an object detector that detects the search object; an action unit capable of carrying out the predetermined action relative to the search object; a device-side communication unit capable of receiving the object data and the action data transmitted from the operation terminal; a storage unit storing an autonomous movement program that causes the mobile search device to autonomously move and a recognition program that compares the object data and object detection data detected by the object detector; and a device-side controller connected to the object detector, the action unit, the device-side communication unit, and the storage unit. While the mobile search device is autonomously moving through the execution of the autonomous movement program, the device-side controller executes the recognition program to compare the object data received by the device-side communication unit with the object detection data detected by the object detector, and in a case where the object data and the object detection data are determined to match with each other as a result of the comparison, carries out the predetermined action relative to the search object using the action unit based on the action data received by the device-side communication unit.

According to this configuration, the search object (e.g., a drill) and the predetermined action (e.g., gripping) can be separately input on the input unit of the operation terminal. Thus, the mobile search device can carry out the input predetermined action relative to the input search object. Here, in a case where the search object is changed to another search object, it is only required to change the search object input on the input unit to another different search object but the input predetermined action does not need to be changed. As a result, the mobile search device can carry out the input predetermined action relative to the another search object that has been input. As described above, the search object and the predetermined action are combined as necessary while being input (given as an instruction) on the input unit of the operation terminal such that a flexible instruction can be provided to the mobile search device. Accordingly, it is no longer necessary to provide an instruction for carrying out a predetermined action relative to a search object (e.g., an instruction for gripping a drill), thereby achieving use for multiple purposes in a wider range.

Advantageously, in the autonomous search system, the storage unit further stores object sample data in regard to the search object, the operation terminal transmits, as the object data to be transmitted to the mobile search device, an object specification signal that specifies the object sample data stored in the storage unit of the mobile search device, and upon acquiring the object specification signal received by the device-side communication unit, the device-side controller acquires, from the storage unit, the object sample data specified by the object specification signal.

According to this configuration, it is only required to store the object sample data to the storage unit of the mobile search device and transmit the object specification signal from the operation terminal. Accordingly, a communication traffic volume from the operation terminal to the mobile search device can be suppressed, whereby the instruction can be quickly provided to the mobile search device from the operation terminal.

Advantageously, in the autonomous search system, the operation terminal transmits, as the object data to be transmitted to the mobile search device, object sample data in regard to the search object, and the device-side controller acquires the object sample data received by the device-side communication unit.

According to this configuration, the object sample data can be transmitted to the mobile search device from the operation terminal. Therefore, even in a case where the object sample data is not stored in the storage unit of the mobile search device in advance, the predetermined action can be carried out relative to the search object in the transmitted object sample data.

Advantageously, in the autonomous search system, the storage unit further stores an action program in regard to the predetermined action, the operation terminal transmits, as the action data to be transmitted to the mobile search device, an action specification signal that specifies the action program stored in the storage unit of the mobile search device, and upon acquiring the action specification signal received by the device-side communication unit, the device-side controller acquires, from the storage unit, the action program specified by the object specification signal.

According to this configuration, it is only required to store the action program to the storage unit of the mobile search device and transmit the action specification signal from the operation terminal. Accordingly, a communication traffic volume from the operation terminal to the mobile search device can be suppressed, whereby the instruction can be quickly provided to the mobile search device from the operation terminal.

Advantageously, in the autonomous search system, the operation terminal transmits, as the action data to be transmitted to the mobile search device, an action program in regard to the predetermined action, and the device-side controller acquires the action program received by the device-side communication unit.

According to this configuration, the action program can be transmitted to the mobile search device from the operation terminal. Therefore, even in a case where the action program is not stored in the storage unit of the mobile search device in advance, the predetermined action in regard to the transmitted action program can be carried out relative to the search object.

Advantageously, in the autonomous search system, the storage unit associates the object data and the action data with each other to accumulate, both of which are transmitted from the operation terminal, and while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

According to this configuration, even in a case where the object data and the action data are not input to the mobile search device from the operation terminal, based on the object data and the action data that have been input in the past, the mobile search device can carry out the predetermined action relative to the search object while autonomously moving. Thus, the mobile search device can learn the action based on the input from the operation terminal.

Advantageously, in the autonomous search system, the object detector includes at least one of a camera capable of imaging the surroundings of the mobile search device, a scanner capable of measuring a space around the mobile search device, a microphone capable of detecting a sound around the mobile search device, and an odor measuring device capable of detecting an odor around the mobile search device.

According to this configuration, the search object can be detected by at least one of the camera, the scanner, the microphone, and the odor measuring device.

Advantageously, in the autonomous search system, remote control that remotely controls the mobile search device can be input to the input unit, and upon acquiring the input of the remote control received by the device-side communication unit, the device-side controller carries out the control based on the input of the remote control by giving precedence thereto over the control during the autonomous movement.

According to this configuration, the control based on the remote control of the mobile search device by the operation terminal can be carried out by taking precedence over the control while the mobile search device is autonomously moving. As a result, the mobile search device can be remotely controlled by the operator operating the operation terminal, whereby the control through the remote control by the operator and the control while the mobile search device is autonomously moving can be coordinated.

Advantageously, in the autonomous search system, the operation terminal further includes a display unit that displays information input from the input unit, and the display unit displays a search object input field to which the search object is input and an action input field to which the predetermined action is input.

According to this configuration, the search object input field for inputting the search object and the action input field for inputting the predetermined action can be displayed on the display unit. Accordingly, the operator operating the operation terminal can favorably input the search object and the predetermined action through the input unit while visually confirming the display unit.

According to another aspect of the present invention, an operation terminal configured to operate a mobile search device that searches for a search object while moving, the operation terminal comprising: an input unit to which the search object and a predetermined action to be carried out relative to the search object can be separately input; a terminal-side communication unit that transmits, to the mobile search device, the search object input on the input unit as object data and transmits, to the mobile search device, the predetermined action input on the input unit as action data; and a terminal-side controller connected to the input unit and the terminal-side communication unit.

According to this configuration, by inputting the search object and the predetermined action separately, the search object and the predetermined action can be combined as necessary while being input (given as an instruction) on the input unit. As a result, a flexible instruction can be provided to the mobile search device, thereby achieving use for multiple purposes in a wider range.

According to still another aspect of the present invention, a mobile search device configured to search for a search object while autonomously moving based on information transmitted from an operation terminal, the mobile search device comparing, while autonomously moving, object data for the search object received from the operation terminal with object detection data obtained while detecting the search object, and in a case where the object data and the object detection data are determined to match with each other as a result of the comparison, carrying out a predetermined action relative to the search object.

According to this configuration, during the autonomous movement, the predetermined action can be carried out relative to the search object matching the object data transmitted from the operation terminal.

According to still another aspect of the present invention, a search control method for an autonomous search system comprising an operation terminal and a mobile search device configured to search for a search object while moving based on information transmitted from the operation terminal, the search control method comprising: a data transmission process of transmitting, to the mobile search device, the search object input on the operation terminal as object data and transmitting, to the mobile search device, a predetermined action to be carried out relative to the search object, which has been input on the operation terminal, as action data; an autonomous movement process of causing the mobile search device to autonomously move; a comparison process of comparing, while the mobile search device is autonomously moving, the object data received by the mobile search device with object detection data detected by an object detector provided in the mobile search device; and an action process of causing the mobile search device to carry out the predetermined action relative to the search object in a case where the search object in the object data and the object detection data are determined to match with each other.

According to this configuration, the search object and the predetermined action input on the operation terminal can be transmitted to the mobile search device as the object data and the action data, respectively. Accordingly, based on the received object data and action data, the mobile search device can carry out the predetermined action relative to the search object. At this time, the search object and the predetermined action are combined as necessary while being input (given as an instruction) to the operation terminal. As a result, a flexible instruction can be provided to the mobile search device, thereby achieving use for multiple purposes in a wider range.

### BRIEF DESCRIPTION OF DRAWINGS

FIG. 1 is a schematic configuration diagram of an autonomous search system according to an embodiment.

FIG. 2 is an explanatory diagram illustrating an exemplary input screen.

FIG. 3 is a flowchart in regard to a search control method for the autonomous search system according to the embodiment.

FIG. 4 is an explanatory diagram illustrating an exemplary action of the autonomous search system.

### DESCRIPTION OF EMBODIMENTS

An embodiment according to the present invention will be described in detail based on the drawings. The embodiment is not construed to limit the invention. Note that the embodiment described below includes components that can be replaced and are easily replaced by those skilled in the art or substantially the same components.

### Embodiment

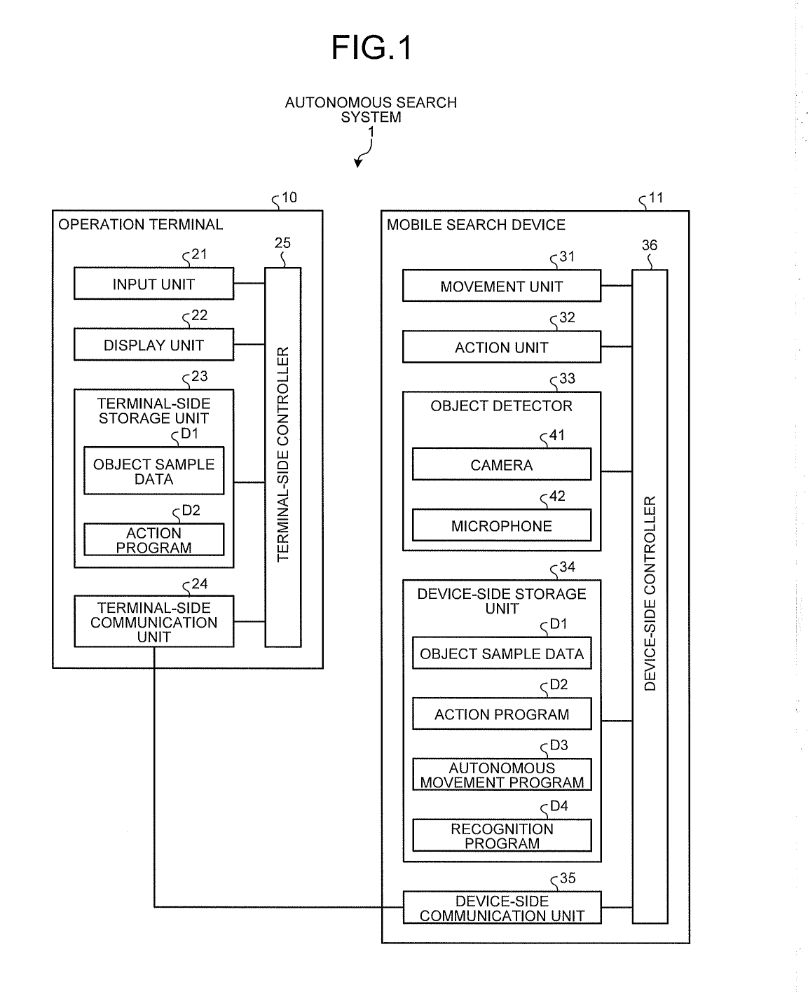

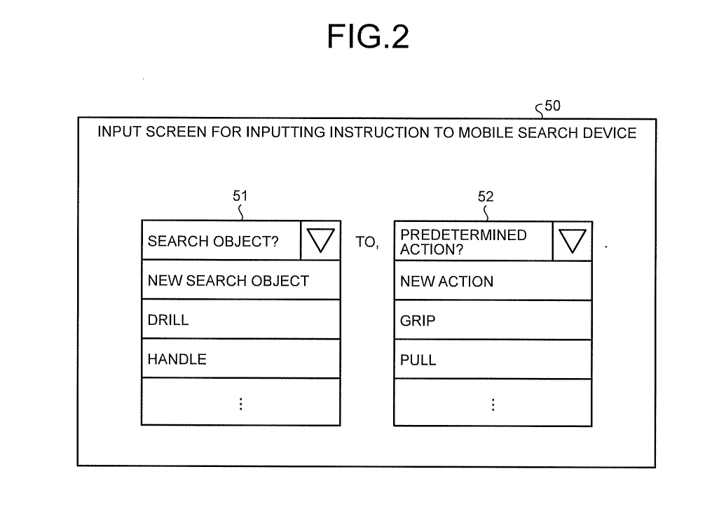

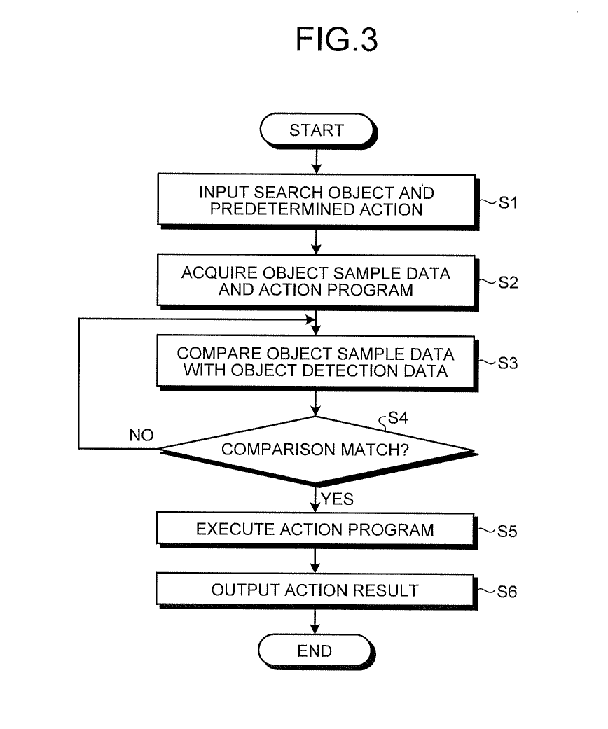

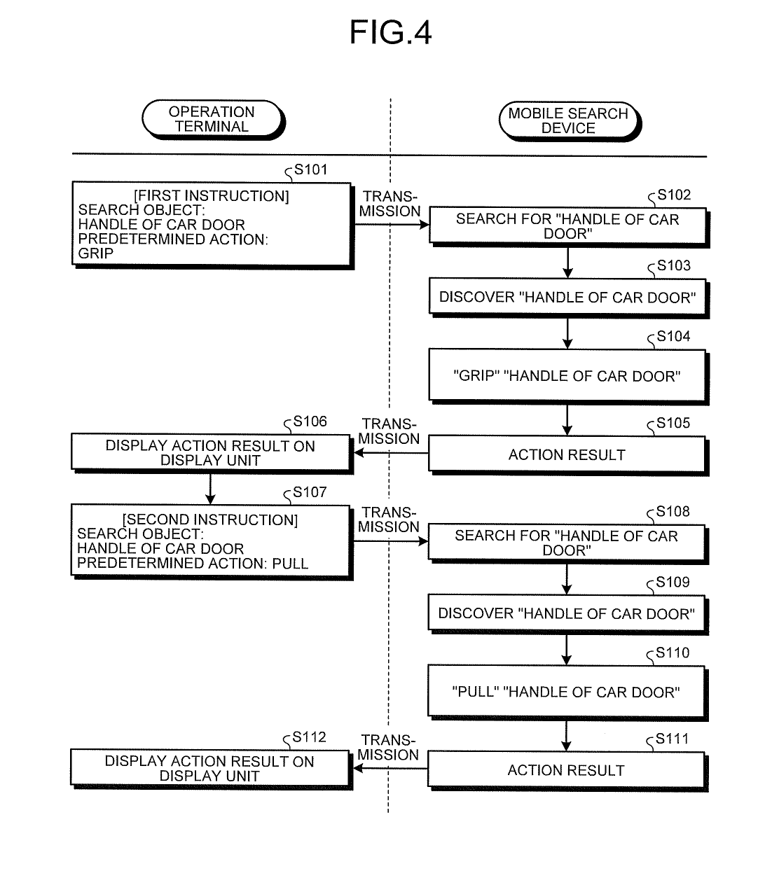

FIG. 1 is a schematic configuration diagram of an autonomous search system according to the embodiment, whereas FIG. 2 is an explanatory diagram illustrating an exemplary input screen. FIG. 3 is a flowchart in regard to a search control method for the autonomous search system according to the embodiment, whereas FIG. 4 is an explanatory diagram illustrating an exemplary action of the autonomous search system.

As illustrated in FIG. 1, the autonomous search system 1 according to the embodiment includes an operation terminal 10 and a mobile search device 11 and serves as a system in which an instruction is provided to the mobile search device 11 from the operation terminal 10 and the mobile search device 11 in turn moves based on the provided instruction to search for a search object.

The operation terminal 10 is a terminal operated by an operator and includes an input unit 21, a display unit 22, a terminal-side storage unit 23, a terminal-side communication unit 24, and a terminal-side controller 25.

Information can be input to the input unit 21 and the input unit 21 is operated by the operator. The operator operates the input unit 21 to input information to be transmitted to the mobile search device 11. Specifically, the operator operates the input unit 21 to input information on a search object to be searched for by the mobile search device 11 or to input information on a predetermined action to be carried out by the mobile search device 11 relative to a search object.

The display unit 22 outputs information to display such that the operator can visually confirm the information. The operator operates the input unit 21 while visually confirming the display unit 22. The display unit 22 also displays information transmitted from the mobile search device 11. Specifically, the operator visually confirms a predetermined input screen displayed on the display unit 22 to input information on a search object or input information on a predetermined action to be carried out relative to a search object. Additionally, the operator visually confirms information displayed on the display unit 22 to subsequently input predetermined information.

The terminal-side storage unit 23 stores various types of information and, for example, stores information to be transmitted to the mobile search device 11 or the like. The information to be transmitted to the mobile search device 11 includes object sample data D1 serving as data in regard to a search object and an action program D2 serving as data in regard to a predetermined action to be carried out relative to a search object.

The terminal-side communication unit 24 communicates with the mobile search device 11 to transmit information to the mobile search device 11 or to receive information from the mobile search device 11. The communication between the terminal-side communication unit 24 and the mobile search device 11 is not particularly limited and may be wired communication or wireless communication.

The terminal-side controller 25 is connected to each of the input unit 21, the display unit 22, the terminal-side storage unit 23, and the terminal-side communication unit 24 to control the respective units. For example, based on information input from the input unit 21, the terminal-side controller 25 transmits predetermined information to the mobile search device 11 through the terminal-side communication unit 24.

Specifically, when information in regard to a search object is input from the input unit 21, the terminal-side controller 25 transmits the input search object to the mobile search device 11 as the object data. The object data serves as the object sample data D1 stored in the terminal-side storage unit 23 of the operation terminal 10 or an object specification signal specifying the object sample data D1 stored in the mobile search device 11. In other words, in the case of transmitting the object sample data D1 stored in the terminal-side storage unit 23 to the mobile search device 11, when information in regard to a search object is input from the input unit 21, the terminal-side controller 25 reads the object sample data D1 corresponding to the input search object from the terminal-side storage unit 23 to transmit the read object sample data D1 to the mobile search device 11. Meanwhile, in the case of specifying the object sample data D1 stored in the mobile search device 11, when information in regard to a search object is input from the input unit 21, the terminal-side controller 25 generates an object specification signal corresponding to the input search object to transmit the generated object specification signal to the mobile search device 11.

Additionally, when information in regard to a predetermined action is input from the input unit 21, the terminal-side controller 25 transmits the input predetermined action to the mobile search device 11 as the action data. The action data serves as the action program D2 stored in the terminal-side storage unit 23 of the operation terminal 10 or an action specification signal specifying the action program D2 stored in the mobile search device 11. In other words, in the case of transmitting the action program D2 stored in the terminal-side storage unit 23 to the mobile search device 11, when information in regard to a predetermined action is input from the input unit 21, the terminal-side controller 25 reads the action program D2 corresponding to the input predetermined action from the terminal-side storage unit 23 to transmit the read action program D2 to the mobile search device 11. Meanwhile, in the case of specifying the action program D2 stored in the mobile search device 11, when information in regard to a predetermined action is input from the input unit 21, the terminal-side controller 25 generates an action specification signal corresponding to the input predetermined action to transmit the generated action specification signal to the mobile search device 11.

As described above, when a search object and a predetermined action are input through the input unit 21, the operation terminal 10 can provide, to the mobile search device 11, an instruction for carrying out the predetermined action relative to the search object.

Next, the mobile search device 11 will be described. The mobile search device 11 is a device that searches for a search object while autonomously moving and capable of carrying out a predetermined action relative to a search object. The mobile search device 11 is, for example, an autonomous movement type robot and includes a movement unit 31, an action unit 32, an object detector 33, a device-side storage unit 34, a device-side communication unit 35, and a device-side controller 36.

The movement unit 31 is used to move the mobile search device 11 and, for example, may be configured by wheels including a driving wheel or alternatively, may be configured by a crawler belt. The movement of the movement unit 31 is controlled by the device-side controller 36 connected thereto.

The action unit 32 is used to carry out a predetermined action relative to a search object. The action unit 32 is, for example, an arm capable of gripping a search object. The action unit 32 is not limited to the arm and may be any mechanism as long as the mechanism can carry out a predetermined action relative to a search object.

The object detector 33 is used to detect a search object and configured by including, for example, a camera 41 and a microphone 42. The camera 41 is capable of imaging the surroundings of the mobile search device 11. The microphone 42 is capable of collecting sounds around the mobile search device 11. The object detector 33 may be any detector as long as the detector can detect a search object. For example, the object detector 33 may include an odor measuring device capable of measuring an odor around the mobile search device 11 or a scanner capable of recognizing a space around the mobile search device 11.

The device-side storage unit 34 stores various types of information and, for example, stores information such as a program executed by the mobile search device 11 and data used by the mobile search device 11. Specifically, the device-side storage unit 34 stores object sample data D1 in regard to a search object, an action program D2 in regard to a predetermined action to be carried out relative to a search object, an autonomous movement program D3 for carrying out the autonomous movement of the movement unit 31, a recognition program D4 for recognizing a search object, and the like. Hereinafter, each of the object sample data D1, the action program D2, the autonomous movement program D3, and the recognition program D4 will be described. The object sample data D1 and the action program D2 stored in the device-side storage unit 34 are similar to the object sample data D1 and the action program D2 stored in the terminal-side storage unit 23, respectively.

The object sample data D1 is sample data used to specify a search object to be searched for by the mobile search device 11. The object sample data D1 is prepared in accordance with the object detector 33 that detects a search object. Specifically, when the camera 41 is used as the object detector 33, image data of the search object is prepared as the object sample data D1. Meanwhile, when the microphone 42 is used as the object detector 33, acoustic data of a sound emitting from the search object is prepared as the object sample data D1. The object sample data D1 can be prepared in accordance with the object detector 33 and thus is not limited to the aforementioned data. For example, the object sample data D1 may be odor data of an odor emitting from a search object corresponding to the odor measuring device, or alternatively, may be three-dimensional data of a search object corresponding to the scanner.

The action program D2 is a program for causing the action unit 32 of the mobile search device 11 to carry out a predetermined action. In a case where the action unit 32 is an arm, the action program D2 serves as, for example, an action program D2 for carrying out a gripping action that grips a search object with the arm, or an action program D2 for carrying out a pull action that pulls a search object with the arm. In a case where the action unit 32 is a different action unit 32 instead of being an arm, an action program D2 corresponding to the different action unit 32 may be prepared.

The autonomous movement program D3 is a program for causing the mobile search device 11 to autonomously move to search for a search object. In a case where acoustic data is provided as the object sample data D1 for a search object, for example, the autonomous movement program D3 serves as an autonomous movement program D3 for collecting sounds of the surroundings using the microphone 42 and then causing the mobile search device 11 to autonomously move in a direction in which a sound corresponding to the acoustic data is emitting (direction of arrival). Here, in order to identify the direction of arrival of the sound, a microphone array including a plurality of microphones is used as the microphone 42. Accordingly, the device-side controller 36 identifies the direction of arrival of the sound based on time differences among detection signals detected by the respective microphones. Meanwhile, in a case where image data is provided as the object sample data D1 for a search object, for example, the autonomous movement program D3 serves as an autonomous movement program D3 for causing the mobile search device 11 to autonomously move while imaging the surroundings using the camera 41 until the captured imaging data matches the image data. The autonomous movement program D3 is not limited to the aforementioned examples and may be any program as long as the program is capable of causing the mobile search device 11 to autonomously move to search for a search object.

The recognition program D4 is a program for comparing object detection data serving as data in regard to a search object detected by the object detector 33 with the object sample data D1. In a case where acoustic data is provided as the object sample data D1 for a search object, for example, the recognition program D4 serves as a recognition program D4 for separating a sound source of the search object from acoustic detection data serving as the object detection data obtained by collecting sounds using the microphone 42 and then comparing the acoustic detection data representing the separated sound source of the search object with the acoustic data. Meanwhile, in a case where image data is provided as the object sample data D1 for a search object, for example, the recognition program D4 serves as a recognition program D4 for imaging the surroundings using the camera 41 and then comparing the captured imaging data with the image data. The recognition program D4 is also not limited to the aforementioned examples and may be any program as long as the program is capable of comparing the object detection data detected by the object detector 33 with the object sample data D1. Subsequently, when the object detection data is found to match the object sample data D1 through the comparison by the recognition program D4, the device-side controller 36 executes the action program D2.

Furthermore, the device-side storage unit 34 has a learning function. In other words, instructions provided from the operation terminal 10 are accumulated in the device-side storage unit 34. Specifically, instructions in which the object data and the action data transmitted from the operation terminal 10 are associated with each other are accumulated in the device-side storage unit 34. Accordingly, based on the instructions stored in the device-side storage unit 34, the device-side controller 36 can autonomously search using the mobile search device 11. At this time, multiple instructions are stored in the device-side storage unit 34. Here, for example, in a case where a first instruction for carrying out a predetermined action relative to a search object and a second instruction for carrying out a different predetermined action relative to the same search object are stored in the device-side storage unit 34, predetermined priorities may be set for the first instruction and the second instruction.

The device-side communication unit 35 communicates with the operation terminal 10 to transmit information to the operation terminal 10 or to receive information from the operation terminal 10. As described above, the communication between the device-side communication unit 35 and the operation terminal 10 is not particularly limited and may be wired communication or wireless communication.

The device-side controller 36 is connected to each of the movement unit 31, the action unit 32, the object detector 33, the device-side storage unit 34, and the device-side communication unit 35 to control the respective units. For example, the device-side controller 36 acquires information received by the device-side communication unit 35 to control the mobile search device 11 based on the acquired information. Specifically, the device-side controller 36 acquires an instruction provided from the operation terminal 10 to control the mobile search device 11 based on the acquired instruction.

More specifically, upon acquiring the object data transmitted from the operation terminal 10, the device-side controller 36 acquires that object data as the object sample data D1 in a case where that object data is the object sample data D1, while acquiring the object sample data D1 stored in the device-side storage unit 34 in a case where that object data is the object specification signal. Subsequently, the device-side controller 36 executes the autonomous movement program D3 and the recognition program D4 to cause the mobile search device 11 to autonomously search for a search object based on the object sample data D1.

Meanwhile, upon acquiring the action data transmitted from the operation terminal 10, the device-side controller 36 acquires that action data as the action program D2 in a case where that action data is the action program D2, while acquiring the action program D2 stored in the device-side storage unit 34 in a case where that action data is the action specification signal. Subsequently, when the comparison by the recognition program D4 between the object detection data and the object sample data D1 is found to have a matching result, the device-side controller 36 executes the action program D2 to carry out a predetermined action relative to a search object using the action unit 32. Once the predetermined action is completed, the device-side controller 36 transmits an action result to the operation terminal 10.

As described above, based on the instruction provided from the operation terminal 10 for carrying out a predetermined action relative to a search object, the mobile search device 11 can carry out the autonomous search and the predetermined action.

Hereinafter, an example where the device-side controller 36 executes the action program D2 will be described. In a case where the action unit 32 is an arm, the action program D2 serves as an action program D2 for carrying out a gripping action that grips a search object with the arm. When the device-side controller 36 executes the action program D2, the device-side controller 36 estimates a position of the search object using a position of the mobile search device 11 as a reference. The position is estimated based on a distance sensor separately provided in the mobile search device 11 or based on an image captured by the camera 41. Thereafter, based on a positional relationship between the mobile search device 11 and the search object, the device-side controller 36 sets a target position relative to the search object for the arm. Subsequently, the device-side controller 36 controls the operation of the arm such that the arm is located at the target position. Specifically, in a case where the arm includes a plurality of joints, the device-side controller 36 controls the arm such that joint angles of the respective joints thereof match such joint angles that enable the arm to be located at the target position. Once the arm is located at the target position, the device-side controller 36 causes the arm to carry out the gripping action. As described above, the device-side controller 36 executes the action program D2 for carrying out the gripping action to thereby cause the arm to grip the search object. When the gripping action has been completed, the device-side controller 36 transmits the action result of the gripping action to the operation terminal 10.

Next, an example of an input screen 50 displayed on the display unit 22 of the operation terminal 10 will be described with reference to FIG. 2. The input screen 50 illustrated in FIG. 2 serves as an input screen 50 for inputting an instruction to the mobile search device 11. In other words, the input screen 50 serves as an input screen 50 for inputting a search object and a predetermined action. A search object input field 51 and an action input field 52 are displayed on this input screen 50. The search object input field 51 is a field for inputting a search object and displays search objects registered in advance or a search object to be newly registered as selectable options. The action input field 52 is a field for inputting a predetermined action and displays predetermined actions registered in advance or a predetermined action to be newly registered as selectable options. The input of a search object and the input of a predetermined action are not particularly limited and a predetermined text string may be input to the respective fields 51 and 52 for a search. Once a search object and a predetermined action are input on the input screen 50, the terminal-side controller 25 transmits the input search object and predetermined action to the mobile search device 11 as the object data and the action data, respectively.

The search object input field 51 and the action input field 52 have been displayed on the single input screen 50. However, the configuration is not limited thereto and, for example, the search object input field 51 and the action input field 52 may be individually displayed on separate input screens.

Next, a control flow in regard to the search control method for the autonomous search system 1 will be described with reference to FIG. 3. First, a search object and a predetermined action are input to the operation terminal 10 through the input unit 21 during operation by the operator (step S1). Once the search object and the predetermined action are input, the operation terminal 10 transmits the object data for the input search object and the action data for the input predetermined action to the mobile search device 11 (data transmission process).

Upon receiving the object data and the action data, the mobile search device 11 acquires the object sample data D1 and the action program D2 based on the object data and the action data, respectively (step S2). Upon acquiring the object sample data D1, the mobile search device 11 executes the autonomous movement program D3 and the recognition program D4 to autonomously search for the search object based on the object sample data D1 (autonomous movement process). Note that the operator can remotely control the mobile search device 11 using the operation terminal 10 while the mobile search device 11 is autonomously moving. Accordingly, the remote control is input to the operation terminal 10 through the input unit 21 during operation by the operator. The operation terminal 10 transmits the input remote control to the mobile search device 11. Upon acquiring the input of the remote control, the device-side controller 36 of the mobile terminal device 11 terminates to carry out the movement control based on the autonomous movement program D3 and gives precedence to the action control based on the input of the remote control to carry out.

While autonomously moving or being remotely controlled, the mobile search device 11 compares the object sample data D1 with the object detection data detected by the object detector 33 (step S3: comparison process). Subsequently, in a case where the object sample data D1 and the object detection data are determined to match with each other as a result of the comparison by the recognition program D4 (step S4: Yes), the mobile search device 11 executes the action program D2 (step S5: action process). On the other hand, in a case where the object sample data D1 and the object detection data are not determined to match with each other as a result of the comparison by the recognition program D4 (step S4: No), the mobile search device 11 proceeds to step S3 again. When the action program D2 is executed in step S5, the mobile search device 11 moves the action unit 32 to carry out the predetermined action relative to the search object. After the predetermined action is completed by the action unit 32, the mobile search device 11 transmits the action result to the operation terminal 10 (step S6).

Next, exemplary operation of the operation terminal 10 and an exemplary action of the mobile search device 11 using the autonomous search system 1 will be described with reference to FIG. 4. The operator operates the operation terminal 10 to input a “handle of car door” as a search object and “gripping” as a predetermined action (step S101). Thereafter, the operator transmits, to the mobile search device 11, a “first instruction” for carrying out the action of “gripping” relative to the “handle of car door”, which have been input on the operation terminal 10. The mobile search device 11 then searches for a “handle of car door” as a search object based on the “first instruction” (step S102). Subsequently, upon discovering a “handle of car door” (step S103), the mobile search device 11 carries out the action of “gripping” as a predetermined action relative to the “handle of car door” (step S104). After completing the gripping action, the mobile search device 11 transmits the action result to the operation terminal 10 (step S105). Upon acquiring the action result, the operation terminal 10 displays the action result on the display unit 22 (step S106).

Following this, the operator confirms the action result and then operates the operation terminal 10 to input the “handle of car door” as a search object and “pulling” as a predetermined action (step S107). Thereafter, the operator transmits, to the mobile search device 11, a “second instruction” for carrying out the action of “pulling” relative to the “handle of car door”, which have been input on the operation terminal 10. The mobile search device 11 then searches for a “handle of car door” as a search object based on the “second instruction” (step S108). At this time, because the mobile search device 11 has already discovered the “handle of car door” in the “first instruction” (step S109), the mobile search device 11 immediately carries out the action of “pulling” as a predetermined action relative to the “handle of car door” (step S110). After completing the pulling action, the mobile search device 11 transmits the action result to the operation terminal 10 (step S111). Upon acquiring the action result, the operation terminal 10 displays the action result on the display unit 22 (step S112).

As described above, the instruction by the operator and the movement/search and the predetermined action by the mobile search device 11 are repeatedly carried out to thereby achieve the autonomous search carried out by the mobile search device 11.

As described thus far, according to the configuration of the embodiment, the search object and the predetermined action can be separately input on the input unit 21 of the operation terminal 10. Thus, the mobile search device 11 can carry out the input predetermined action relative to the input search object. At this time, in a case where the search object is changed to another search object, it is only required to change the search object input on the input unit 21 to another different search object but the input predetermined action does not need to be changed. As a result, the mobile search device 11 can carry out the input predetermined action relative to the another search object that has been input. As described above, the search object and the predetermined action are combined as necessary while being input (given as an instruction) on the input unit 21 of the operation terminal 10 such that a flexible instruction can be provided to the mobile search device 11. Accordingly, the autonomous search system 1 can be used for multiple purposes in a wider range.

Additionally, according to the configuration of the embodiment, it is possible to store the object sample data D1 to the device-side storage unit 34 of the mobile search device 11 and transmit the object specification signal from the operation terminal 10. Accordingly, a communication traffic volume from the operation terminal 10 to the mobile search device 11 can be suppressed, whereby the instruction can be quickly provided to the mobile search device 11 from the operation terminal 10.

According to the configuration of the embodiment, the object sample data D1 can be also transmitted to the mobile search device 11 from the operation terminal 10. Therefore, even in a case where the object sample data D1 is not stored in the device-side storage unit 34 of the mobile search device 11 in advance, the predetermined action can be carried out relative to the search object in the transmitted object sample data D1.

Furthermore, according to the configuration of the embodiment, it is possible to store the action program D2 to the device-side storage unit 34 of the mobile search device 11 and transmit the action specification signal from the operation terminal 10. Accordingly, a communication traffic volume from the operation terminal 10 to the mobile search device 11 can be suppressed, whereby the instruction can be quickly provided to the mobile search device 11 from the operation terminal 10.

According to the configuration of the embodiment, the action program D2 can be also transmitted to the mobile search device 11 from the operation terminal 10. Therefore, even in a case where the action program D2 is not stored in the device-side storage unit 34 of the mobile search device 11 in advance, the predetermined action in regard to the transmitted action program D2 can be carried out relative to the search object.

According to the configuration of the embodiment, because the mobile search device 11 has the learning function, even in a case where no instruction is given to the mobile search device 11 from the operation terminal 10, the mobile search device 11 can also carry out the predetermined action relative to the search object based on an instruction in the past while autonomously moving.

Additionally, according to the configuration of the embodiment, the camera 41 and the microphone 42 can be applied as the object detector 33. In addition to the camera 41 and the microphone 42, the scanner and the odor measuring device can be applied as well.

According to the configuration of the embodiment, the remote control by the operator is also available while the mobile search device 11 is autonomously moving. Therefore, the control through the remote control by the operator and the control while the mobile search device 11 is autonomously moving can be coordinated.

Furthermore, according to the configuration of the embodiment, the search object input field 51 and the action input field 52 can be displayed on the display unit 22. As a result, the operator operating the operation terminal 10 can favorably input the search object and the predetermined action through the input unit 21 while visually confirming the display unit 22.

In the embodiment, the mobile search device 11 has carried out the predetermined action relative to the search object in a case where the object data and the object detection data are determined to match with each other. However, a determination result may be transmitted to the operation terminal 10 prior to carrying out the predetermined action. Specifically, when the device-side controller 36 determines that the object data and the object detection data match with each other, the mobile search device 11 transmits the determination result to the operation terminal 10 while blocking the action unit 32 from carrying out the predetermined action relative to the search object until acquiring, from the operation terminal 10, input of the permission for carrying out the predetermined action. Meanwhile, the operation terminal 10 displays the received determination result on the display unit 22. When the operator inputs the permission for carrying out the predetermined action through the input unit 21, the operation terminal 10 transmits the permission for carrying out the predetermined action to the mobile search device 11. Upon acquiring the input of the permission for carrying out the predetermined action, the mobile search device 11 carries out the predetermined action relative to the search object. According to this configuration, the predetermined action relative to the search object can be carried out depending on the determination of the operator.

### REFERENCE SIGNS LIST

1 AUTONOMOUS SEARCH SYSTEM
10 OPERATION TERMINAL
11 MOBILE SEARCH DEVICE
21 INPUT UNIT
22 DISPLAY UNIT
23 TERMINAL-SIDE STORAGE UNIT
24 TERMINAL-SIDE COMMUNICATION UNIT
25 TERMINAL-SIDE CONTROLLER
31 MOVEMENT UNIT
32 ACTION UNIT
33 OBJECT DETECTOR
34 DEVICE-SIDE STORAGE UNIT
35 DEVICE-SIDE COMMUNICATION UNIT
36 DEVICE-SIDE CONTROLLER
41 CAMERA
42 MICROPHONE
50 INPUT SCREEN
51 SEARCH OBJECT INPUT FIELD
52 ACTION INPUT FIELD
D1 OBJECT SAMPLE DATA
D2 ACTION PROGRAM
D3 AUTONOMOUS MOVEMENT PROGRAM
D4 RECOGNITION PROGRAM

1. An autonomous search system comprising:
an operation terminal; and
a mobile search device configured to search for a search object while moving based on information transmitted from the operation terminal, wherein
the operation terminal includes:
an input unit to which the search object and a predetermined action to be carried out relative to the search object can be separately input;
a terminal-side communication unit that transmits, to the mobile search device, the search object input on the input unit as object data and transmits, to the mobile search device, the predetermined action input on the input unit as action data; and
a terminal-side controller connected to the input unit and the terminal-side communication unit,
the mobile search device includes:
an object detector that detects the search object;
an action unit capable of carrying out the predetermined action relative to the search object;
a device-side communication unit capable of receiving the object data and the action data transmitted from the operation terminal;
a storage unit storing an autonomous movement program that causes the mobile search device to autonomously move and a recognition program that compares the object data and object detection data detected by the object detector; and
a device-side controller connected to the object detector, the action unit, the device-side communication unit, and the storage unit, and
while the mobile search device is autonomously moving through the execution of the autonomous movement program, the device-side controller executes the recognition program to compare the object data received by the device-side communication unit with the object detection data detected by the object detector, and in a case where the object data and the object detection data are determined to match with each other as a result of the comparison, carries out the predetermined action relative to the search object using the action unit based on the action data received by the device-side communication unit, and
wherein the object detector includes at least one of a camera capable of imaging the surroundings of the mobile search device, a scanner capable of measuring a space around the mobile search device, a microphone capable of detecting a sound around the mobile search device, and an odor measuring device capable of detecting an odor around the mobile search device.

2. The autonomous search system according to claim 1, wherein
the storage unit further stores object sample data in regard to the search object,
the operation terminal transmits, as the object data to be transmitted to the mobile search device, an object specification signal that specifies the object sample data stored in the storage unit of the mobile search device, and
upon acquiring the object specification signal received by the device-side communication unit, the device-side controller acquires, from the storage unit, the object sample data specified by the object specification signal.

3. The autonomous search system according to claim 1, wherein
the operation terminal transmits, as the object data to be transmitted to the mobile search device, object sample data in regard to the search object, and
the device-side controller acquires the object sample data received by the device-side communication unit.

4. The autonomous search system according to claim 1, wherein
the storage unit further stores an action program in regard to the predetermined action,
the operation terminal transmits, as the action data to be transmitted to the mobile search device, an action specification signal that specifies the action program stored in the storage unit of the mobile search device, and
upon acquiring the action specification signal received by the device-side communication unit, the device-side controller acquires, from the storage unit, the action program specified by the object specification signal.

5. The autonomous search system according to claim 1, wherein
the operation terminal transmits, as the action data to be transmitted to the mobile search device, an action program in regard to the predetermined action, and
the device-side controller acquires the action program received by the device-side communication unit.

6. The autonomous search system according to claim 1, wherein
the storage unit associates the object data and the action data with each other to accumulate, both of which are transmitted from the operation terminal, and
while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

7. (canceled)

8. The autonomous search system according to claim 1, wherein
remote control that remotely controls the mobile search device can be input to the input unit, and
upon acquiring the input of the remote control received by the device-side communication unit, the device-side controller carries out the control based on the input of the remote control by giving precedence thereto over the control during the autonomous movement.

9. The autonomous search system according to claim 1, wherein
the operation terminal further includes a display unit that displays information input from the input unit, and
the display unit displays a search object input field to which the search object is input and an action input field to which the predetermined action is input.

10. (canceled)

11. (canceled)

12. A search control method for an autonomous search system comprising an operation terminal and a mobile search device configured to search for a search object while moving based on information transmitted from the operation terminal, the search control method comprising:
a data transmission process of transmitting, to the mobile search device, the search object input on the operation terminal as object data and transmitting, to the mobile search device, a predetermined action to be carried out relative to the search object, which has been input on the operation terminal, as action data;
an autonomous movement process of causing the mobile search device to autonomously move;
a comparison process of comparing, while the mobile search device is autonomously moving, the object data received by the mobile search device with object detection data detected by an object detector provided in the mobile search device; and
an action process of causing the mobile search device to carry out the predetermined action relative to the search object in a case where the search object in the object data and the object detection data are determined to match with each other,
wherein the comparison process includes obtaining the object detection data by using at least one of a camera capable of imaging the surroundings of the mobile search device, a scanner capable of measuring a space around the mobile search device, a microphone capable of detecting a sound around the mobile search device, and an odor measuring device capable of detecting an odor around the mobile search device.

13. The autonomous search system according to claim 2, wherein
the storage unit further stores an action program in regard to the predetermined action,
the operation terminal transmits, as the action data to be transmitted to the mobile search device, an action specification signal that specifies the action program stored in the storage unit of the mobile search device, and
upon acquiring the action specification signal received by the device-side communication unit, the device-side controller acquires, from the storage unit, the action program specified by the object specification signal.

14. The autonomous search system according to claim 3, wherein
the storage unit further stores an action program in regard to the predetermined action,
the operation terminal transmits, as the action data to be transmitted to the mobile search device, an action specification signal that specifies the action program stored in the storage unit of the mobile search device, and
upon acquiring the action specification signal received by the device-side communication unit, the device-side controller acquires, from the storage unit, the action program specified by the object specification signal.

15. The autonomous search system according to claim 2, wherein
the operation terminal transmits, as the action data to be transmitted to the mobile search device, an action program in regard to the predetermined action, and
the device-side controller acquires the action program received by the device-side communication unit.

16. The autonomous search system according to claim 3, wherein
the operation terminal transmits, as the action data to be transmitted to the mobile search device, an action program in regard to the predetermined action, and
the device-side controller acquires the action program received by the device-side communication unit.

17. The autonomous search system according to claim 2, wherein
the storage unit associates the object data and the action data with each other to accumulate, both of which are transmitted from the operation terminal, and
while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

18. The autonomous search system according to claim 3, wherein
the storage unit associates the object data and the action data with each other to accumulate, both of which are transmitted from the operation terminal, and
while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

19. The autonomous search system according to claim 4, wherein
the storage unit associates the object data and the action data with each other to accumulate, both of which are transmitted from the operation terminal, and
while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

20. The autonomous search system according to claim 5, wherein
the storage unit associates the object data and the action data with each other to accumulate, both of which are transmitted from the operation terminal, and
while the mobile search device is autonomously moving through the execution of the autonomous movement program, the device-side controller executes the recognition program to compare the object data accumulated in the storage unit with the object detection data detected by the object detector, and in a case where the object data and the object detection data are determined to match with each other as a result of the comparison, carries out the predetermined action relative to the search object using the action unit based on the action data accumulated in the storage unit.

21. The autonomous search system according to claim 2 wherein
remote control that remotely controls the mobile search device can be input to the input unit, and
upon acquiring the input of the remote control received by the device-side communication unit, the device-side controller carries out the control based on the input of the remote control by giving precedence thereto over the control during the autonomous movement.

22. The autonomous search system according to claim 3 wherein
remote control that remotely controls the mobile search device can be input to the input unit, and
upon acquiring the input of the remote control received by the device-side communication unit, the device-side controller carries out the control based on the input of the remote control by giving precedence thereto over the control during the autonomous movement.

23. The autonomous search system according to claim 4 wherein
remote control that remotely controls the mobile search device can be input to the input unit, and
upon acquiring the input of the remote control received by the device-side communication unit, the device-side controller carries out the control based on the input of the remote control by giving precedence thereto over the control during the autonomous movement.
